(19) United States
(12) Patent Application Publication
(10) Pub. No.: US 2025/0379932 A1
(43) Pub. Date: Dec. 11, 2025

(54) Interactive Video Using Large-Format Display and Mobile Device

(71) Applicant: Nurture Holdings, Inc., Mercer Island, WA (US)

(72) Inventors: Julie D. Stewart, West Vancouver (CA); Scott T. Stewart, West Vancouver (CA); Dananjaya Roshdy, Singapore (SG); Ephemeral Roshdy, Barcelona (ES)

(73) Assignee: Nurture Holdings, Inc., Mercer Island, WA (US)

(21) Appl. No.: 19/226,434

(22) Filed: Jun. 3, 2025

Related U.S. Application Data
(60) Provisional application No. 63/658,780, filed on Jun. 11, 2024.

(51) Int. Cl. H04M 1/72427; H04M 1/72409; H04M 1/72469; H04M 1/72484; H04M 3/56

(52) U.S. Cl. CPC H04M 1/72427; H04M 1/72409; H04M 1/72469; H04M 1/72484; H04M 3/567

(57) ABSTRACT

Methods for user-interactive video between multiple screens use an application on mobile device to generate video on its local screen as well as a large format display. In the video on the large display, animated characters can make simulated videoconference calls to a user on the mobile device. They can also move, apparently, out of the display and onto the mobile device screen. On the mobile screen, the characters can coordinate games and exercises with the user in a seemingly more intimate fashion than if the characters were confined to the large format display. They can help point out real buttons and features on the mobile device from the screen of the mobile device and then hop back to the large display.

### CROSS-REFERENCES TO RELATED APPLICATIONS

This application claims the benefit of U.S. Provisional Application No. 63/658,780, filed 11 Jun. 2024, the contents of which are hereby incorporated by reference in their entirety for all purposed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### 1. Field of the Art

Embodiments of the present invention generally relate to an interactive television (TV) show using a separate, mobile screen input/output device into which characters from the TV show may appear.

### 2. Description of the Related Art

Broadcast TV shows and streaming content are typically one-way: from broadcaster to viewing audience. Long-wave radio frequency and cable broadcast technologies have enabled the inexpensive widespread dissemination of news, political discourse, sports, arts and music, and entertainment for close to a century. And the Internet has enabled video content to be streamed separately to different viewers at disparate times, allowing just about anyone to watch a show on their own schedule. Yet there is a lack of direct interaction between viewers and the characters on screen that they watch.

Some exceptions include live events in which the audience may call in or streaming events allowing live chat with the audience. However, the interactions can still be awkward and seemingly forced, muted behind the different communication channels necessary to communicate.

Young children readily pick up new technologies, as unhindered as they are during their open experimentation with it. They often seek interaction with animated characters as if they were fellow beings of the real world. Toddlers have been known to approach and stand in front of TVs at an early age, some even touching the glass display as if touching the characters portrayed thereon. Yet the characters in videos do not interact from that touch. At best, to connect with the character a child may find a toy with a likeness of the character or control a video game with the character in it.

Video games are often controlled by joysticks and button switches. Mobile video games sometimes employ hand gestures upon a touch-sensitive display, and motion-sensing input-based systems, such as the Nintendo Wii® game console and Microsoft KINECT® computer hardware, can measure body movements. Some input movements are more intuitive than others.

FIG. 1 illustrates a driving game on a personal computer (PC) monitor in which an entire smart phone is used for steering a vehicle. The user, in a first-person view within a vehicle, turns the entire smart phone as if it were a steering wheel. The smart phone's gyroscope and accelerometers are used to detect which way the phone is oriented with respect to gravity and with respect to their starting point, and tilt inputs are sent to the PC. The particular app. shown is Tilt Racer. While such applications are intuitive for anyone who drives or bicycles, they are more difficult for younger children. And the introduction of such an input device is more or less completely disconnected with on screen characters. Young children, who may be otherwise fully capable of rotating a smart phone like a steering wheel, may have no anchoring experience on doing so and may not understand written or oral directions. They may need something more.

There is a need in the art for more organic, seamless, and intuitive interaction between characters in videos and children.

### BRIEF SUMMARY

Generally, a pseudo-video call from an animated character on a large format television (TV) to a viewer's smart phone or other mobile device is described in which the character is shown on the TV initiating a call, an incoming call screen on the phone is replicated, and a front view of the animated character starts talking on the phone's screen when the user answers. The incoming call screen can be selected based upon the model of the smart phone. The TV can show a non-frontal view of the character talking to a camera so as to complete an illusion that the animated character actually persists somewhere else but is talking to the user on the phone.

In another instance, the animated character can appear to move from the TV to the viewer's smart phone and then interact with the user through the smart phone. A rapid animation of the character moving, after being shown preparing to move, off of the TV display, and a correspondingly rapid and synchronized animation of the character moving within the smart phone screen, enables the special effect. A viewer can pat the character using the smart phone's touch screen, which provides gesture positions so as to animate the character as if he, she, or it is physically being touched. The character may be animated to point to local buttons or features on the smart phone based upon the model or operating system. After interaction with the viewer, the character can be shown to move back to the TV again.

Because these aforementioned features require tight and rapid synchronization between the TV and smart phone (or other mobile device), the smart phone's microprocessor is employed to execute the underlying master application and render views for both the phone and TV, employ local videocasting to send the view to the TV.

In another instance, an animated character can direct a breathing exercise with a user of a mobile device, sensing the user's out breath by way of broadband sound detection through the mobile device's microphone. Based on the timing of the sensed out breath, the character may proceed to direct the user to perform further deep breaths and be animated to breath in synchrony with the user.

Some embodiments of the invention are related to a method for simultaneous interactive video through multiple electronic devices, the method including providing an application on a mobile device having a screen, streaming a video to a large format, fixed display, the video presenting an animated character, the screen and display viewed by a user, animating the character in the video to depict the character taking steps to initiate communications, rendering, on the screen of the mobile device, a face-on camera view of the character communicating to the user in a videoconference, receiving, on the mobile device, a user input, and rendering, on the screen of the mobile device or on the fixed display, a response to the input.

The method can further include depicting, on the screen of the mobile device, a representation of an incoming call on the mobile device. It can further include detecting an operating system of the mobile device and selecting the representation from multiple representations, each representation of the multiple representations associated with a different operating system. It can include depicting, on the screen of the mobile device, a representation of an ended call on the mobile device.

The method can further include depicting, on the display and simultaneous with the communicating, a second camera view of the character performing the communications, the second view of the character on the display being different from the face-on view of the character. The second view of the character can be ¼ front view of the character, a profile view of the character, a ¾ rear view of the character, or a back view of the character.

The method can further include rendering the character to gesticulate non-conventional controls of a video game to be played on the display and allowing the user to control the video game using the non-conventional controls. The user input can include non-conventional controls such as touch screen gestures, rotating the mobile device, shaking the mobile device, and/or speaking or breathing into a microphone of the mobile device.

The method can further include detecting a model of the mobile device, looking up attributes of the mobile device, and rendering, on the screen of the mobile device, the character pointing off screen to a physical element on the actual mobile device.

Some embodiments are related to simulating object permanence of animated interactive characters through multiple electronic devices, the method including providing an application on a mobile device having a screen, streaming a video to a large format, fixed display, the video presenting an animated character, the screen and display viewed by a user, depicting the character in the video display preparing to move off of the display, animating the character moving off of the display, rendering the character on the screen of the mobile device immediately after the character moves off of the display, receiving, on the mobile device, a user input to interact with the character on the screen, and rendering, on the screen of the mobile device, a response of the character to the user input.

The user input can include touch screen gestures that simulate touching the character. The user input can include rotating or shaking the mobile device, and the method can further include detecting a rotation or shaking from an accelerometer or gyroscope in the mobile device, and animating the character in response to the detecting. The method can further include depicting, on the screen of the mobile device, the character preparing to move off of the screen, animating the character moving off of the screen, and rendering the character on the video display immediately after the character moving off of the screen.

Some embodiments are related to a method for regulating breathing using a smart phone, the method including providing an application on a mobile device having a screen, the screen viewed by a user, animating, on the screen, a character asking the user to breath in, animating, on the screen, the character asking the user to breath out, receiving an out breath sound into a microphone of the mobile device, analyzing the sound for frequency and duration, determining that the sound is atonal broadband white noise over a duration greater than 0.5 seconds, thereby indicating an out breath by the user, signifying receipt of the noise on the screen, and animating, in response to the determination, the character to ask for another breath in from the user.

The method can further include rendering the character to breathe in and out with the user.

Some embodiments are related to a machine-readable tangible medium embodying information indicative of instructions for causing one or more machines to perform operations for the methods described above.

Some embodiments are related to a system, the system including a memory and at least one processor operatively coupled with the memory and executing program code from the memory for the methods described above.

### BRIEF DESCRIPTION OF THE DRAWINGS

FIG. 1 illustrates a driving game on a personal computer (PC) monitor using a mobile phone's gyroscope and accelerometers to steer the car, per prior art.

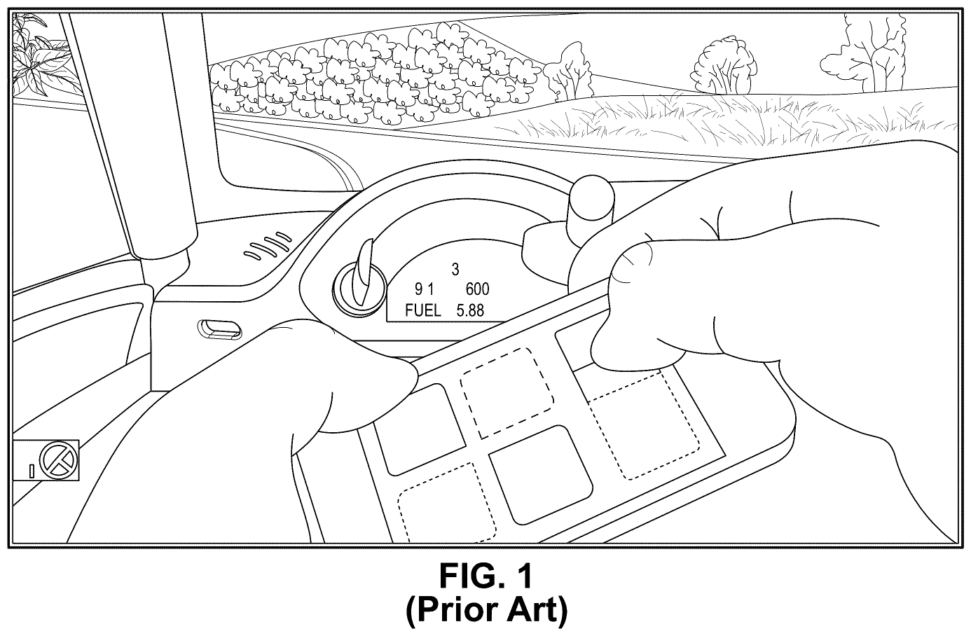

FIG. 2A illustrates a character on a television (TV) taking steps to initiate communication with a real mobile phone in the foreground, in accordance with an embodiment.

FIG. 2B illustrates a representation of an incoming call on the mobile device of FIG. 2A.

FIG. 2C illustrates the character of FIG. 2A appearing in a simulated video call on the mobile device.

FIG. 2D illustrates a profile view of the character on the large display during the simulated video call of FIG. 2C.

FIG. 2E illustrates the character in the simulated video call of FIG. 2C gesticulating off screen as to how to rotate the mobile device as an aircraft yoke.

FIG. 2F illustrates a representation of an ended call of FIG. 2C.

FIG. 3 is a flowchart of a process in accordance with an embodiment.

FIG. 4A illustrates a dog character on a TV and a mobile device in accordance with an embodiment.

FIG. 4B illustrates the dog character of FIG. 4A preparing to jump to the mobile device.

FIG. 4C illustrates the character of FIG. 4B in a simulated jump through the fourth wall in accordance with an embodiment.

FIG. 4D illustrates the character entering the screen in the mobile device immediately after the simulated jump of FIG. 4C.

FIG. 4E illustrates the character apparently resident in the mobile device after landing in the mobile device of FIG. 4D.

FIG. 4F illustrates the character of FIG. 4D receiving a simulated belly rub from a user on the mobile device touch screen.

FIG. 4G illustrates the character of FIG. 4D presenting an award to the user.

FIG. 5 is a flowchart of a process in accordance with an embodiment.

FIG. 6A illustrates the introduction of a character-led, smart phone microphone enabled breathing exercise in accordance with an embodiment.

FIG. 6B illustrates the character of FIG. 6A demonstrating breathing in.

FIG. 6C illustrates the character of FIG. 6A demonstrating breathing out.

FIG. 7 illustrates unconventional control of graphic effects in accordance with an embodiment.

FIG. 8 is a flowchart of a process in accordance with an embodiment.

FIG. 9 is a unified modeling language (UML) sequence diagram of communications sent between a TV stick on which resides an app. for the TV, a mobile app. on the smart phone, and a user, in accordance with an embodiment.

FIG. 10 shows a block diagram of an example computer system usable with systems and methods according to embodiments of the present invention.

### DETAILED DESCRIPTION

A mobile application (“app”) on a smart phone or other mobile electronic device can be paired with an app. executing on a large, fixed television (TV) display, or device plugged into the display, to enable an entertaining and engaging interaction between animated 2-dimensional (2D) or 3-dimensional (3D) characters and their viewers. Through the TV app., or otherwise, the mobile app. can show video that is synchronized with video on the mobile device's own local screen.

Tight coupling and synchronization can make the viewing experience feel more immersive, engaging, and helpful to viewers. Certain aspects may enable teaching younger children than could be educated before through the use of video screens, for example in reinforcing the theory of the mind or object permanence.

A “mobile device” includes a handheld or worn electronic device with a screen display and a means for communications through the electromagnetic spectrum, such as a cellular, satellite, BLUETOOTH® communications, Wi-Fi communications, infrared, or other means, or as otherwise known in the art. Examples of mobile devices include smart phones, tablets, laptop computers, virtual reality or augmented reality glasses, smart watches, or other hand portable digital devices. A mobile device is sometimes referred to interchangeably with smart phone in this specification.

A “cellular” mobile device includes a mobile device that has provisions for cellular or satellite phone communications, or as otherwise known in the art. The cellular or satellite phone communications need not be necessarily currently enabled for the communications.

A “representation of an incoming call” on a cellular mobile device includes a visual page, sound, and/or vibration replicating a look and feel of a telephony and/or videocall app. on the mobile device when then mobile device receives a request for telephone call from another device, or as otherwise known in the art. For example, the page may include a large button with text indicating to accept a call and/or a picture of the call initiator. A sound may indicate a ringtone. The telephony app. that is being replicated may or may not be associated with the brand, operating system, or model of the particular device. The page, sound, and/or vibration may or may not match the current settings associated with a telephony or videocall app. currently enabled on the mobile device.

A “representation of an ended call” may include a visual page, sound, and/or vibration replicating a look and feel of a telephony and/or videocall app. on the mobile device when then mobile device ends a telephone call from another device, or as otherwise known in the art. For example the page may indicate that the call has ended and/or a call duration.

A “gesture” on a touch screen includes tapping, swiping, dragging, pinching, rotating, and other single- or multiple-finger touches on the touch screen for any user input purpose to a device, or as otherwise known in the art.

A “videoconference,” or video call, includes a telephone call with video of at least one caller, or similar facsimile to such a call, or as otherwise known in the art.

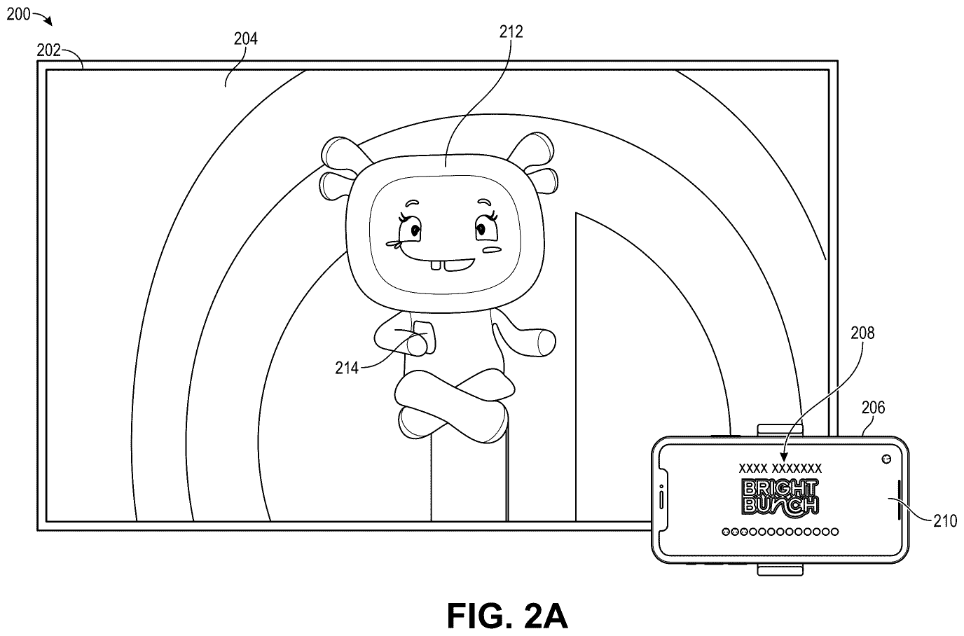

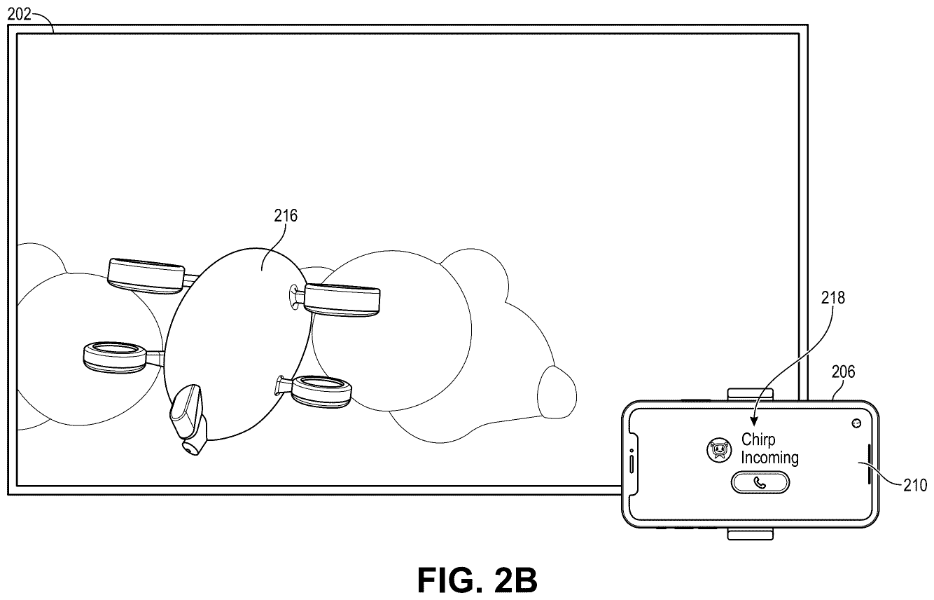

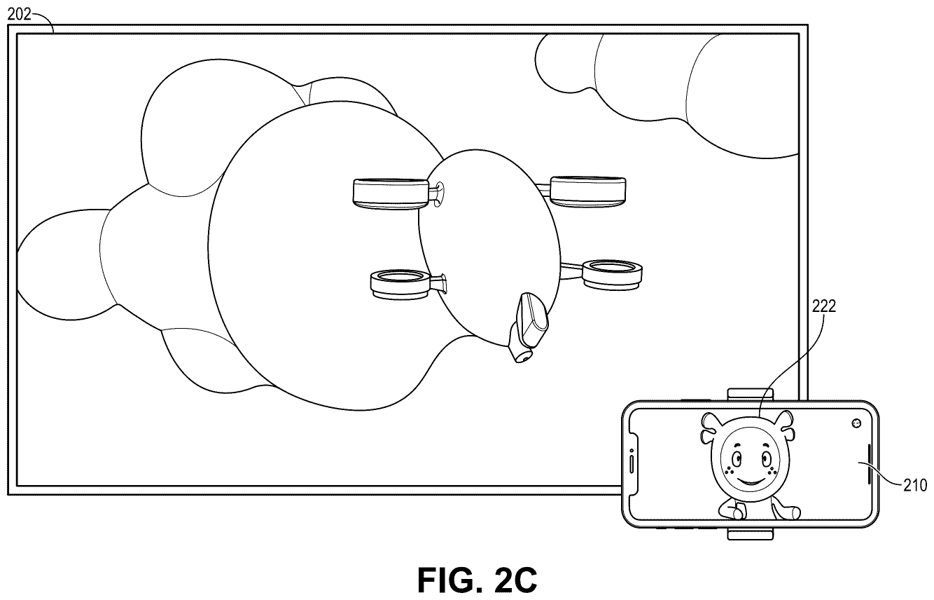

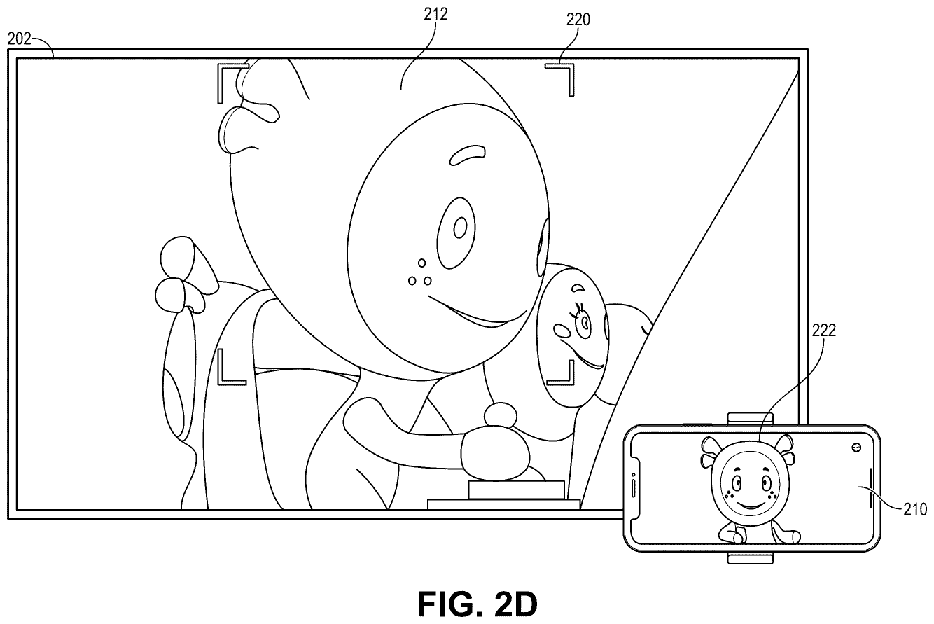

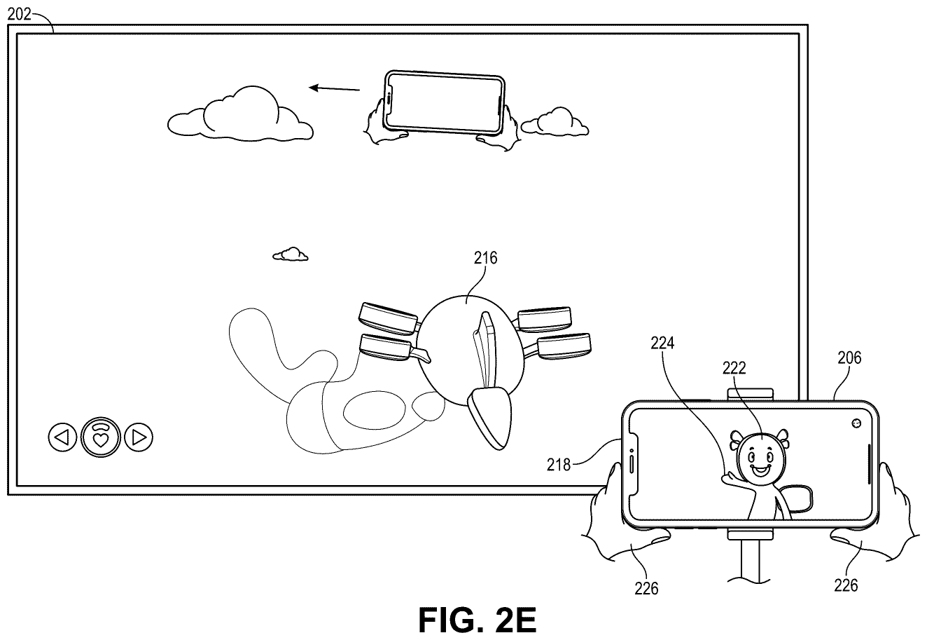

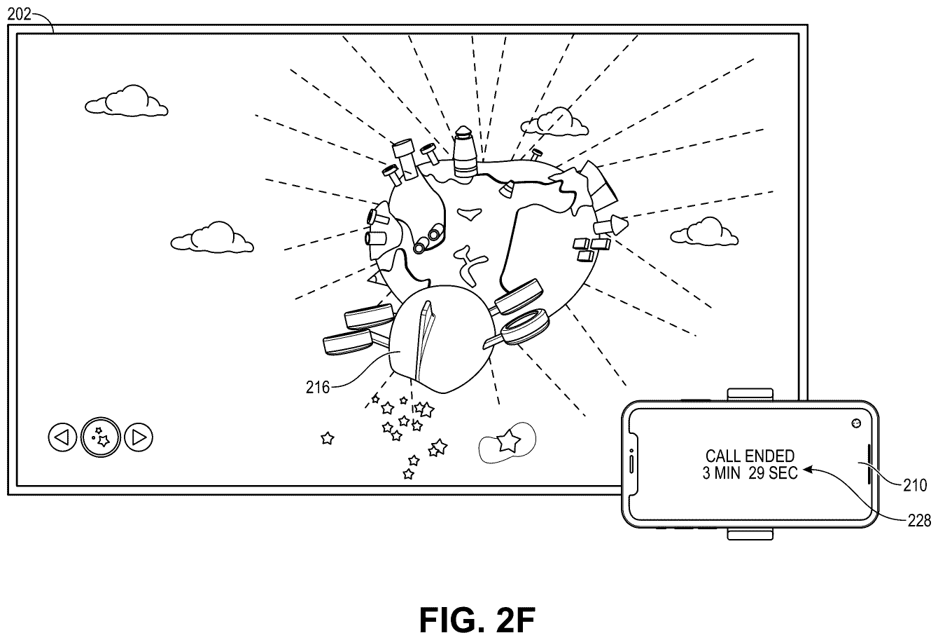

FIGS. 2A-2F illustrate a simulated video call from a character in a video to a local, real smart phone. The real phone is not called through normal cellular service; rather, the call is simulated in the mobile phone app. and timed with the TV app.

In the figures, a large format, fixed TV is in the background while a mobile smart phone is mounted on a tripod in the lower righthand corner. The TV and phone app. have been synchronized, with the phone's processor churning out views for both the TV display and mobile device screen.

FIG. 2A illustrates system 200 in which smart phone 206 runs application 208 shown on screen 210. App. 208 has been set up to communicate with large format, fixed television (TV) display 202. Smart phone app. 208 renders video 204, which is shown on display 202.

Cute, lovable animated character 212 is shown in video 204 on large, fixed display 202. At some point in the video, this protagonist character 212 is shown taking steps to initiate communication by bringing out his own device 214.

Events in the video lead to the character and his fellow characters coming into trouble, out-of-control inside an airship they are piloting. They apparently need help to pilot the airship. The character decides to call a friend.

Character 212 is animated to announce to his friends that he is going to make a call and to push buttons on device 214 with his paws. In this way, the character establishes the moment as one to communicate with someone not in the video. The scene in the large display pans out to a powered airship vehicle in which the character resides. The character wants help because he is having trouble controlling the airship vehicle.

FIG. 2B illustrates airship 216 on large display 202, the airship that is in trouble and in which the character and his friends are traveling. It is from this shot that a representation of an incoming call is shown on screen 210 of the smart phone.

The app. on the mobile device 206 presents a full screen representation of an incoming call on screen 210. The actual mobile device is “ringing,” simulating an incoming call from the character. Mobile device 206 sounds its audible telephony ringer, playing an incoming call ringtone. Just like for an incoming call, the device's vibration mechanism kicks in and vibrates mobile device 206—just like a genuine phone call.

In some embodiments, the character is seen looking at the communications device in its hands, waiting for the call to go through. The two screens can have differently rendered content regarding the same character. For example, the back of the character may be shown on the TV while the front of the character is shown on the phone in a “videocall.” Yet the two views of the character are synched in gestures and body movement.

In some embodiments, the app. detects an operating system of the mobile device. The app. can do this by directly polling the operating system software or infer it by detecting the brand or telephony app. Some telephony apps. are associated with certain brands and models. The app. then selects a representation of an incoming call from among a list of representations, each representation of the multiple representations associated with a different operating system. For example, if the smart phone's operating system is detected as iOS, then an Apple iPhone® telephony app. screen is selected from a selection of stored screens. An iOS device has been known to display an incoming call screen with circular buttons on a black background. Other stored representations can include those the Google Android® telephony app.

The app. may check settings for whether the smart phone is in silent mode, low power mode, accessibility mode, or other modes that affect how the phone would react if a real telephone call were coming in. For example, in silent mode, a smart phone may not audibly ring but instead vibrate the device. As another example, a low power mode may shorten or omit a power-dissipating vibration and only display a screen for an incoming call.

In the figure, a picture of the character is shown alongside his name on the incoming call representation on screen 210. Moreover, the representation includes a telephone icon on a large, call-to-action button, inviting the user to press the button on the mobile phone touch screen to answer the call.

Once the user presses the button to answer the call, a simulated video call experience is presented. Alternatively, after a certain number of rings when it is apparent the user is not going to press it, the pseudo videoconference begins.

FIG. 2C illustrates character 222 speaking from smart phone screen 210 as if in a videoconference with the user. The character is shown in a face-on camera view, just like a view one would have of a person communicating to the user in a real videoconference.

The character may be shown moving too close to the camera, looking askew as if looking at a screen instead of a camera, reaching past the camera, or in other gestures common in videoconferences.

The app. may include camera artifacts that are common in videoconference imagers, such as a fish eye effect, slight graying or other color desaturation in comparison with the video on the large TV, or automatic camera pan and zoom effects found in some commercial videoconference software. The app. may intentionally insert pixelated sections, character halos, imperfect virtual backgrounds, delayed video frames, temporary dropouts, or other glitches to improve realism. A buffering status timer can be displayed on the screen.

FIG. 2D illustrates large display 202 showing profile view 220 of character 212 while simultaneously showing the face-on camera view of character 222 on screen 210. The character shown both on the large display and the mobile device screen are synchronized to continue the illusion that the character on the TV is speaking through a video call to the user's actual phone.

Alternative to a profile (side) view of the character, ¼ front view, ¾ rear view, or a back view of the character can be shown. A goal is to have a different view of the character than that seen through the videoconference screen. The lips, facial expressions, and gestures of the character are synchronized between the display and screen to reinforce the illusion.

A technical advantage of the app. on the smart phone rendering both video frames for the smart phone's screen and the TV display is that the video frames can be tightly synchronized, reinforcing the illusion of a videoconference. This can be important especially for a young child who is learning the Theory of the Mind, i.e., that other beings are separate from them and have their own thoughts and feelings.

That said, the app. can purposely introduce delays and glitches between the video on the display and the videoconference screen on the mobile device. The character on the large display, which in this case is treated as an instantaneous view of the character in his world, is shown ahead of whatever delay is introduced for the videoconference. The character on the display may even be seen commenting on dropouts in communications-even if the videoconference front face-on view shuts off.

FIG. 2E shows large format display 202 with airship 216 in powered flight. Character 222 in the videoconference on smart phone screen 206 is encouraging the user to participate in a lively video game and teaching the user how to drive the airship. The airship is controlled by rotating entire smartphone 206 left or right, like a steering wheel or yoke. Gyroscopic hardware input from the mobile device is used to control vehicles or objects displayed on the display and/or mobile screen.

Rotating an entire smartphone is considered a non-conventional control for a video game because it does not involve a joystick, (direction) D-pad, simple buttons, or triggers. Other non-conventional controls include inputs such as touch screen gestures, shaking the mobile device, and speaking or breathing into a microphone of the mobile device.

In the figure, character 222 is shown gesticulating, pointing to side button 218 on the outside of physical smart phone 206. Character 222 patiently explains that tilting the device will steer the airship and that the button can increase thrust.

User's hands 226 grab and rotate smart phone 206, following the directions of the helpful character. The videoconferenced character does not need to be shown on the main display, leaving the full display for video game graphics.

A technical advantage of a character shown within the smartphone gesturing to physical features on the phone is that younger children may be shown how to operate a video game or otherwise use a mobile device for input. To a certain extent among the cultures of the world, gestures can be divorced from language. This this case, spoken and written language does not need to be relied upon to explain the controls.

The exemplary system comprises a mobile application developed in Unity, a programming and scripting language promulgated by Unity Software Inc. of San Francisco, California (doing business as Unity Technologies). The mobile app. captures gyroscopic data from the host device and broadcasts the data.

Unlike conventional joystick and button inputs to most video games, gyroscopic data from a mobile device is used to control objects displayed on a separate TV screen. Traditional controllers can be bulky and less intuitive. Using a mobile device leverages a familiar, ubiquitous device, providing a more natural and immersive control method. Unlike traditional game controllers or single-screen applications, the system presented leverages the inherent gyroscopic sensors in smart phones to provide a more intuitive and immersive control mechanism. Small children with small hands may be able to better use the whole phone as a controller.

In some embodiments, the character explains from the large display how to use the phone as a steering wheel to guide the vehicle through a series of clouds. The character is shown speaking, and then with an L cut continues to speak as the mobile device screen switches to animated instructions for controlling the vehicle.

In some embodiments, facial expressions and mouth movements of the character in the app. are synchronized with the same character on the screen while the character describes to the user what help is needed. The user may talk into the microphone of the smart phone, triggering interactive gestures from the character, such as nodding, shaking its head, tilting its head to the side in a question-like manner, smiles, etc. The character may interrupt the user after a period of time in order to resume the streaming show, or it may wait patiently in perpetuity as the user talks.

The user, now a player of a video game, can continue with game play and be encouraged (or heckled) by the character in the videoconference on his or her smart phone. In the exemplary game, airship 216 is guided among targets and clouds. A gyroscope and accelerometers in the phone measure where the gravity vector is and roll, pitch, and yaw from its initial position to calculate tilt of the phone and thus control the airship on the TV.

At the end of game play, control can be discontinued such that the smart phone no longer guides the vehicle, and control is handed back to the character.

FIG. 2F illustrates representation 228 of an ended call on smart phone screen 210. The representation shows that the call has ended as well as a duration of the call.

The ended call representation may include other post-videoconference options, such as buttons to call the user back, transcribe the meeting to create a transcript, and/or generate an artificial intelligence (AI) powered summary.

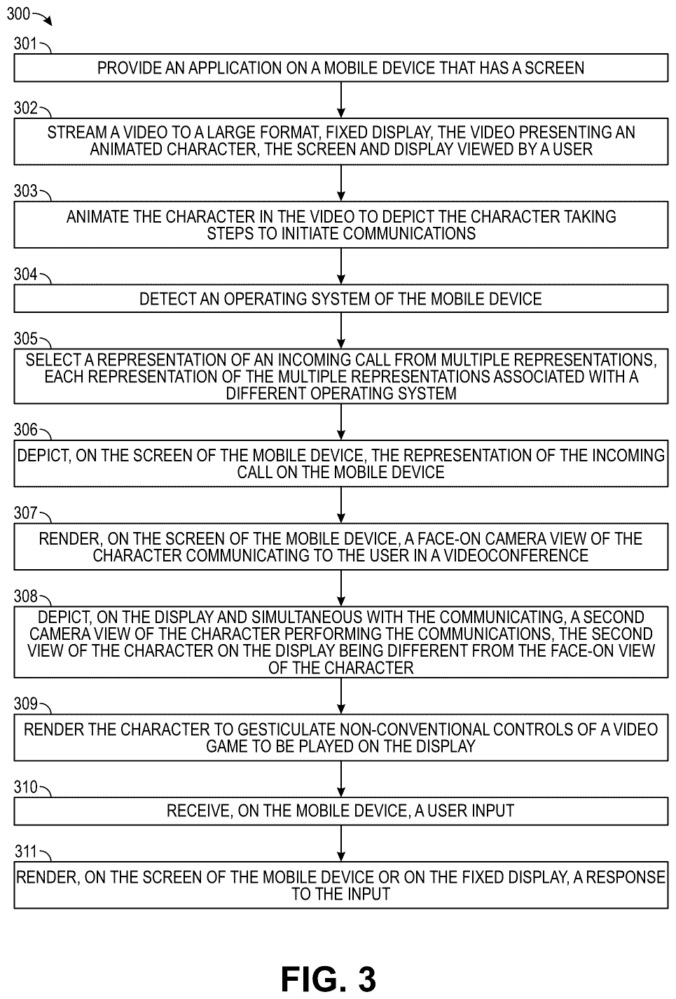

FIG. 3 is a flowchart of process 300 in accordance with an embodiment. In operation 301, an application is provided on a mobile device that has a screen. In operation 302, a video is streamed to a large format, fixed display, the video presenting an animated character, the screen and display viewed by a user. In operation 303, the character in the video is animated to depict him or her taking steps to initiate communications. In operation 304, an operating system of the mobile device is detected. In operation 305, a representation of an incoming call is selected from among multiple representations, each representation of the multiple representations associated with a different operating system. In operation 306, the selected representation of the incoming call on the mobile device is depicted on the screen of the mobile device. In operation 307, a face-on view of the character communicating to the user in a videoconference is rendered on the screen of the mobile device. In operation 308, a second camera view of the character performing the communications is depicted on the display, simultaneous with the communicating, the second view of the character on the display being different from the face-on view of the character. In operation 309, the character is rendered to gesticulate non-conventional controls of a video game to be played on the display. In operation 310, a user input is received on the mobile device. In operation 311, a response to the input is rendered on the screen of the mobile device or on the fixed display.

Other character interactions using a mobile device and fixed display can be useful for interacting with young children or adults whose first language is not that of the video game locale setting.

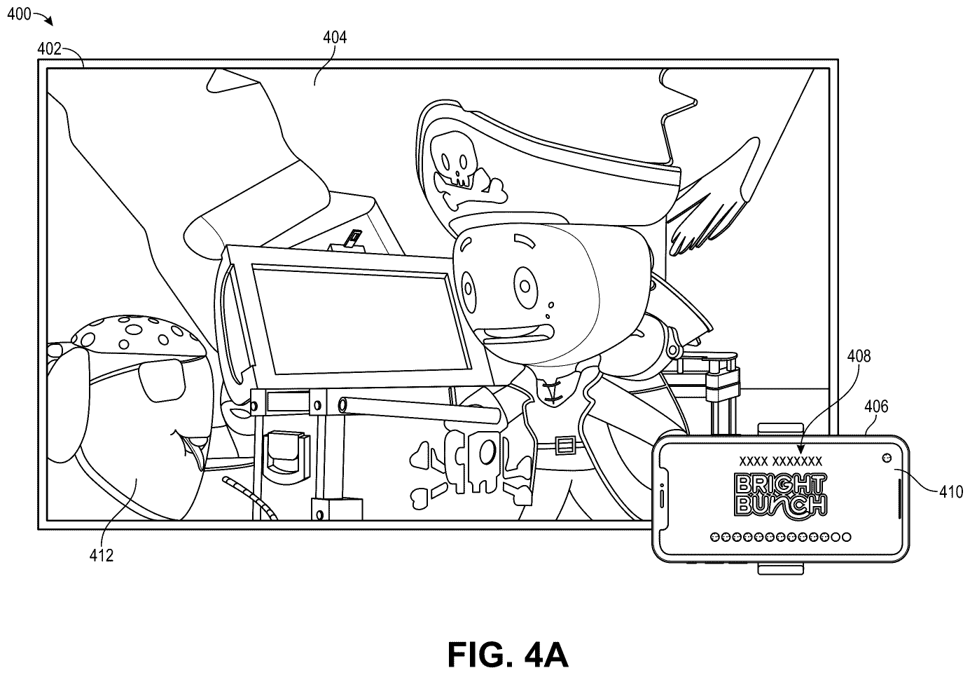

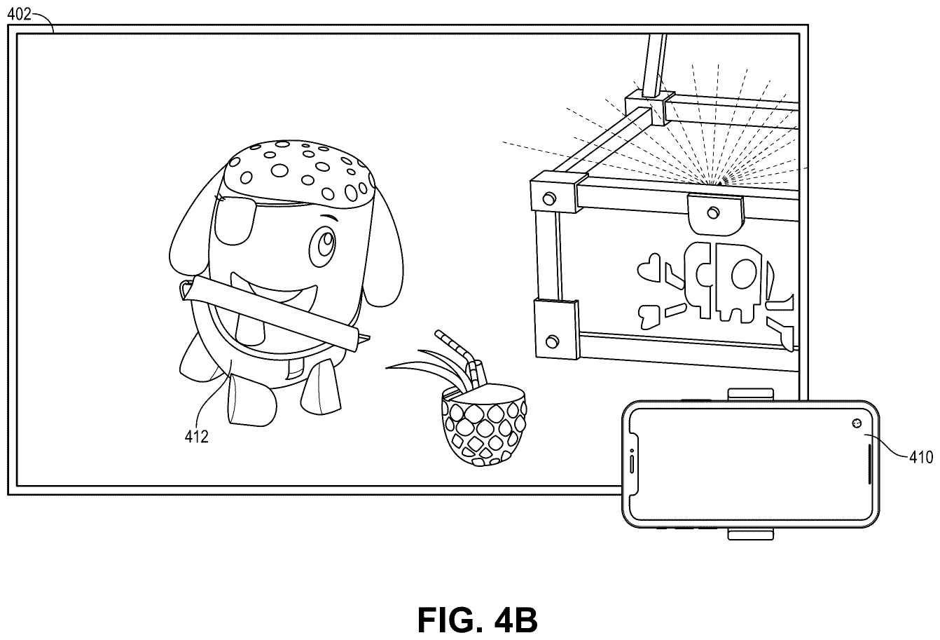

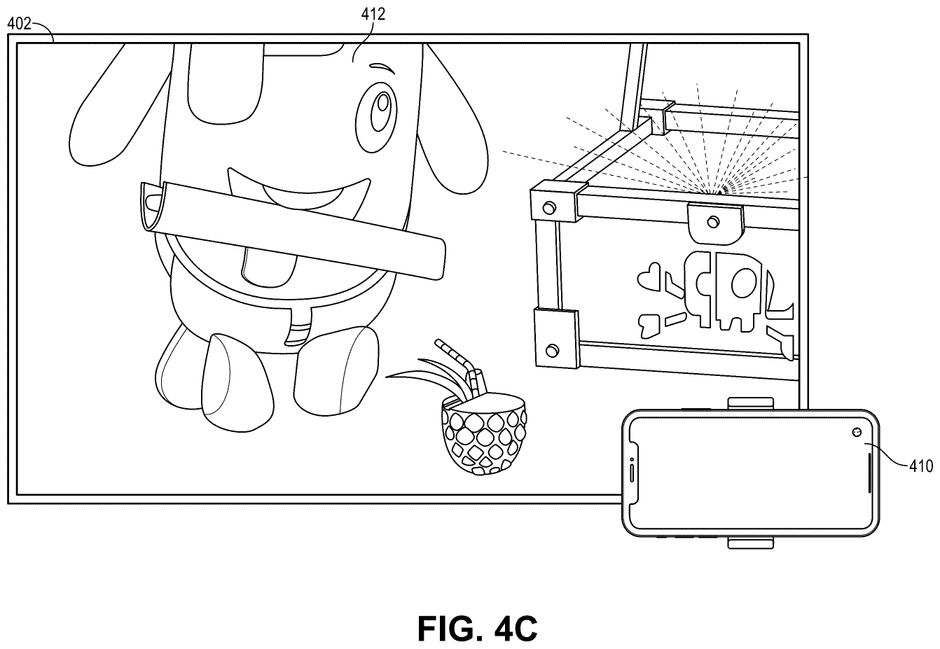

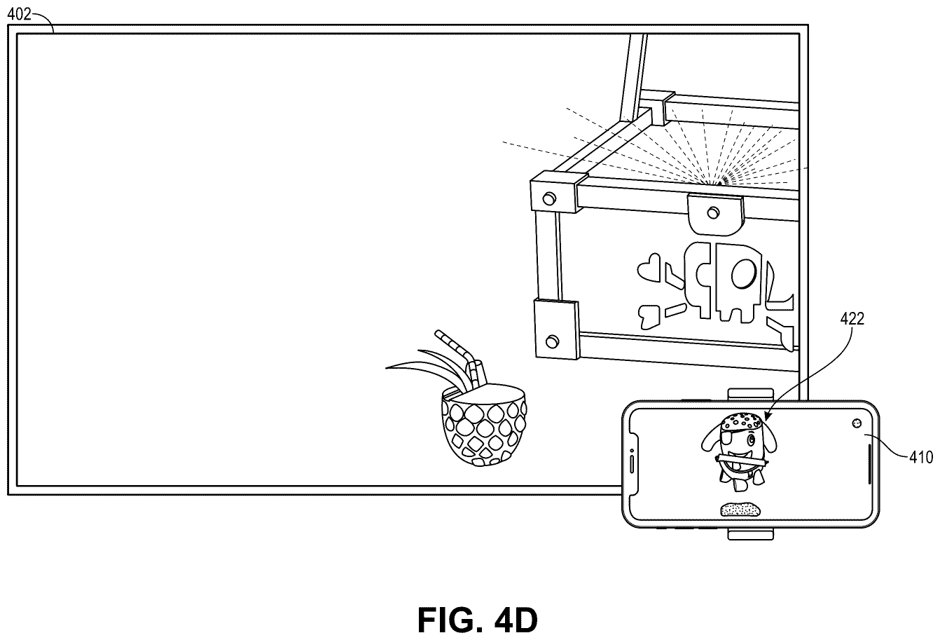

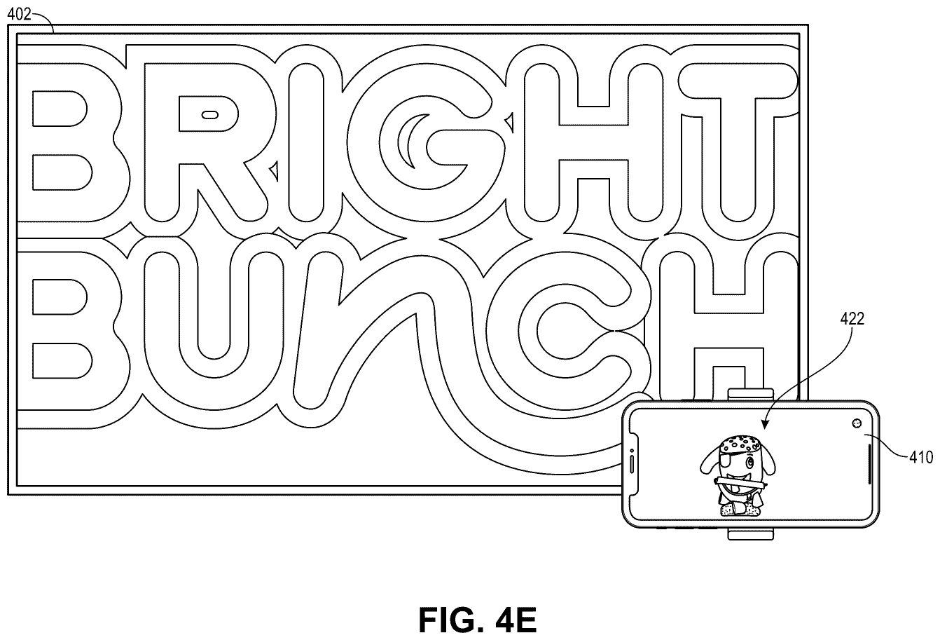

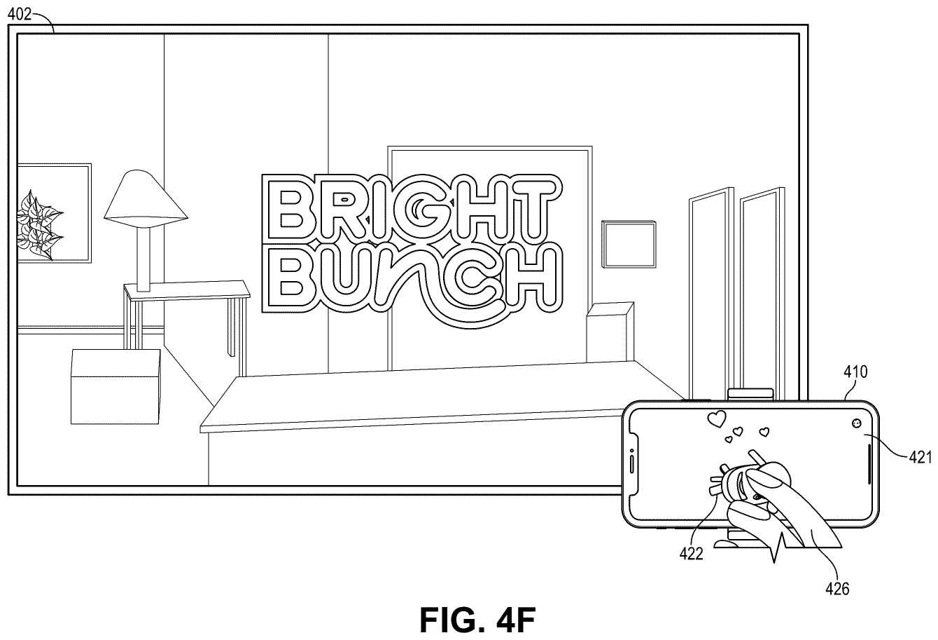

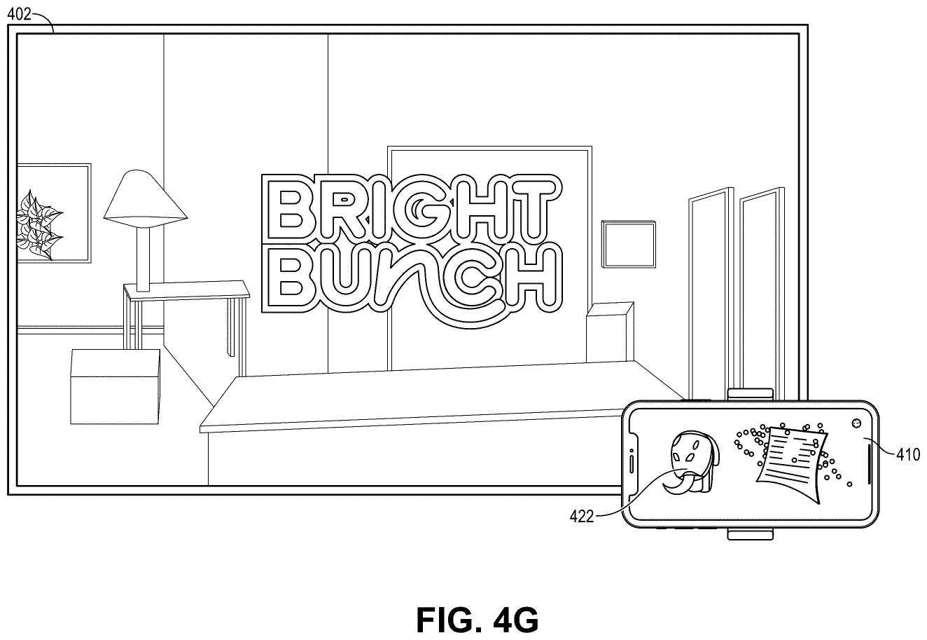

FIGS. 4A-4G illustrate a dog character “jumping” from a TV display to a mobile device to interact with a user and get a belly rub through the mobile device's touch screen.

FIG. 4A illustrates system 400 in which smart phone 406 runs application 408 on screen 410. App. 408 has been set up to communicate with large format, fixed television (TV) display 402. App. 408 renders video 404, which is shown on display 402.

The figure shows dog character 412 on the large display 402 receiving a message that is rolled up in a scroll. He is told to deliver a “thank you” message to the user.

FIG. 4B illustrates character 412 preparing to jump to the mobile device. He wags his tail, circles the screen, then eyes out of the fourth wall, signaling an intent to jump and move off of display 402. Mobile device screen 410 is blank, having been cleared of other graphics.

In some embodiments, the mobile device screen shows a stage or landing pad so that it is apparent to a user that the character will move to that screen. The screen may flash, or there may be an audible sound, to draw attention to the mobile device.

The dog character then jumps.

FIG. 4C shows character 412 in mid jump towards camera and off the screen. The animation occurs in a fraction of a second so as to complete the illusion. This is made possible by tight coupling between the app. on the mobile device and the display, having the processer within the mobile device render both views and then cast one of the views to the large screen.

In some embodiments, the character can move off of the display to the left, right, top, or bottom. The character can walk, run, jump, swim, fall, drive, fly, be propelled, or otherwise move in some fashion off of the display.

FIG. 4D illustrates the character 422 coming on to the screen of the mobile device immediately after the simulated jump. This establishes that the character came from somewhere and can move and occupy different (virtual) spaces.

FIG. 4E illustrates dog character 422 completing his jump and landing within mobile device screen 410. There can be haptic feedback from the phone as he lands in order to switch the focus of the viewer from the TV to the phone.

To the viewer, character 422 is apparently resident in mobile device screen 410. The dog character barks, explores around, and otherwise moves in the screen of the smart phone as he did when in the TV.

In some embodiments, the character may act like he is in a more confined space, being in the mobile device screen, than in the display. If, determined by a media query or otherwise, it is detected that the screen to which the character moves is larger than the primary display, the character may act like it is in more expansive area.

Meanwhile, the empty scene that the dog character left is subject to a quick wipe transition to allow the view to understand that the dog character is no longer present on the TV display and that attention should be focused elsewhere.

FIG. 4F illustrates dog character 422 on mobile device screen 410.

From his antics, he has convinced user 426 to rub the mobile device touch screen 421 over him so that he receives a simulated belly rub. The character may also be pet or stroked using touch screen 421.

After the user pets the dog character, he releases the scroll that he fetched earlier in order to deliver its message. The scroll unfurls, revealing the “gift” for the player.

FIG. 4G illustrates character 422 on mobile device screen 410 with the opened scroll. The scroll displays an actual, real-world recipe for a treat for the user. The character waits patiently next to the recipe so as to allow a viewer to focus on the recipe and copy it down, if necessary.

The ability for characters to jump between the two screens, either automatically or interactively, enhances user engagement. It can also be more intuitive and enjoyable for small children to see their characters obey object permanence, even though the characters are electronic and otherwise ephemeral to the world. For adults, such interaction moves beyond static content streaming to a dynamic, interactive environment, differentiating it from existing solutions and addressing the demand for more engaging multimedia experiences.

In some embodiments, characters can jump between screens in real-time, driven by user interactions or automated events. There can be bi-directional interaction that supports both automatic and user-initiated transitions, creating a dynamic interactive experience. There can be seamless animation synchronization, ensuring that animations are smoothly coordinated between devices, providing a cohesive user experience.

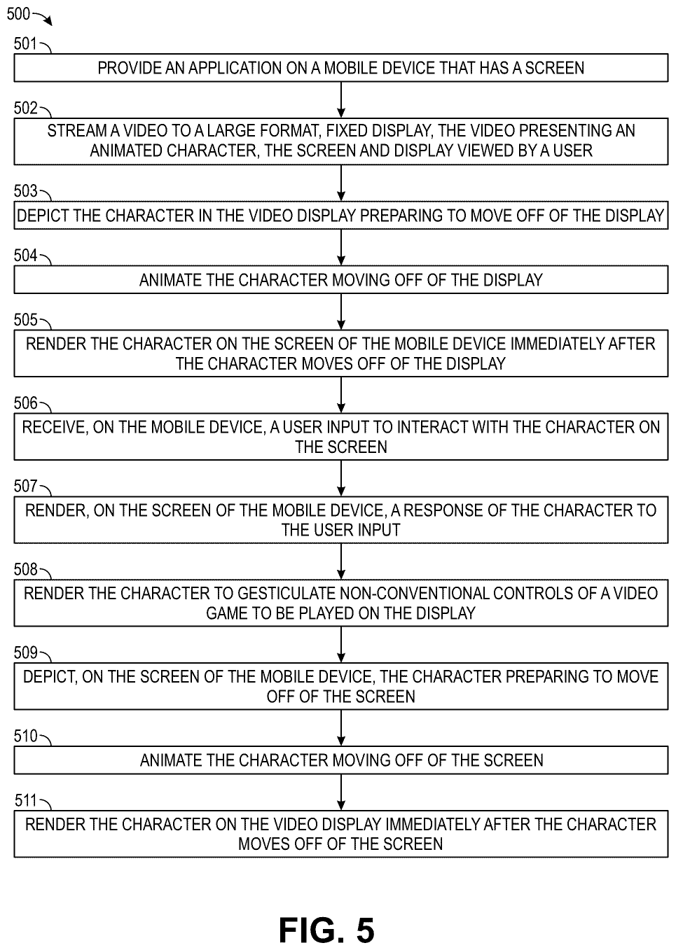

FIG. 5 is a flowchart of process 500 in accordance with an embodiment. In operation 501, an application is provided on a mobile device that has a screen. In operation 502, a video is streamed to a large format, fixed display, the video presenting an animated character, the screen and display viewed by a user. In operation 503, the character in the video display is depicted to be preparing to move off of the display. In operation 504, the character is animated to move off of the display. In operation 505, the character is rendered on the screen of the mobile device immediately after the character moves off of the large display. In operation 506, a user input to interact with the character on the screen is received on the mobile device. In operation 507, a response of the character to the user input is rendered on the screen of the mobile device. In operation 508, the character is rendered to gesticulate non-conventional controls of a video game to be played on the display. In operation 509, the character is depicted on the screen of the mobile device as preparing to move off of the screen. In operation 510, the character is animated moving off of the mobile device screen. In operation 511, the character is rendered on the video display immediately after the character moves off of the screen.

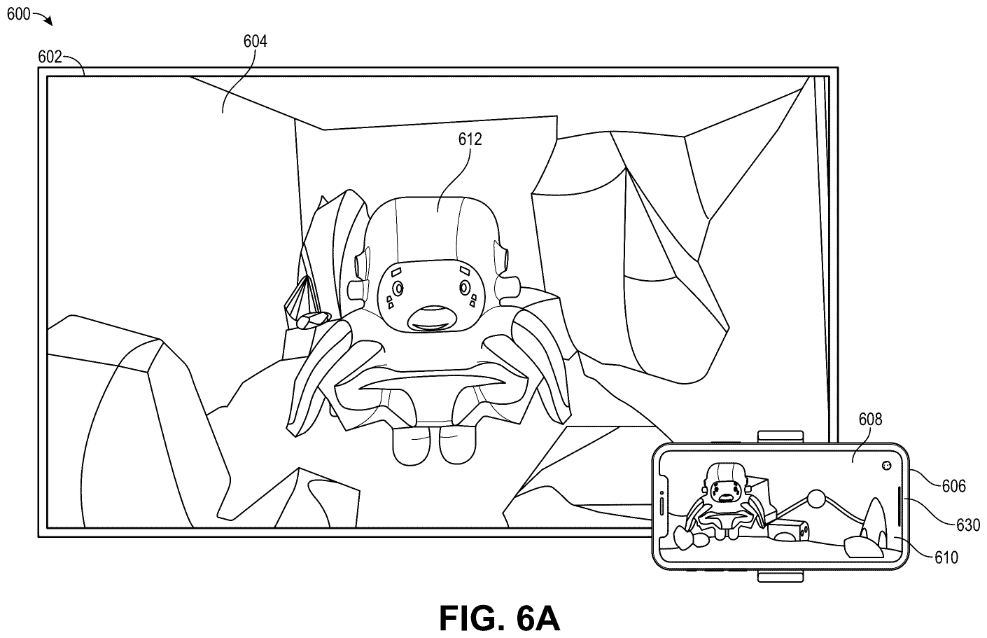

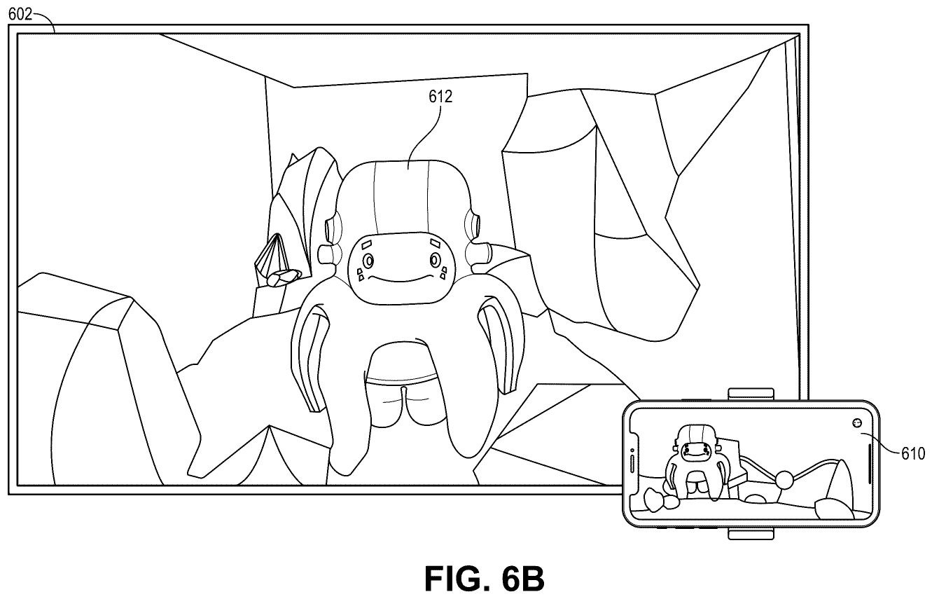

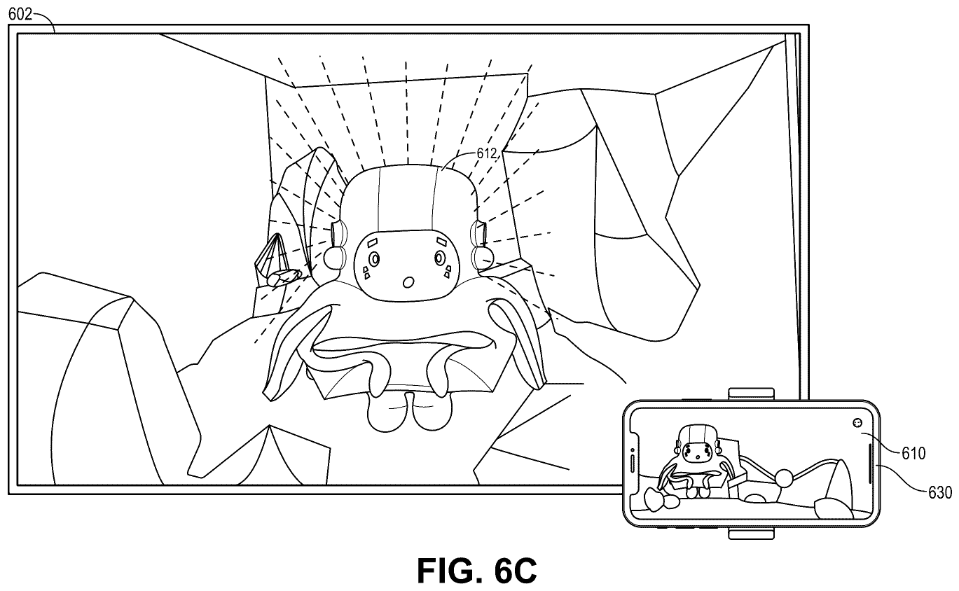

FIGS. 6A-8D illustrate a technology-assisted breathing health exercise in which a human user breathes into the microphone input of the phone and sees a response on both the phone and the TV to aid in mindfulness.

FIG. 6A illustrates system 600 in which display 602 runs video 604 of character 612 that is animated to ask the viewer for help in calming down the character. Mobile device 606 runs app. 608, which shows images on screen 610 and sends images to display 602.

Character 612 is animated to ask the viewer to breathe with him. He encourages the user to hold the smart phone mobile device close so that the character can hear the user through the microphone of the mobile phone.

FIG. 6B illustrates character 612 on display 602 demonstrating a breathing-in part of the breathing exercise. On mobile screen 610, a sinusoidal diagram is shown to the right of the character, helping the user see where they should be in the breathing pattern.

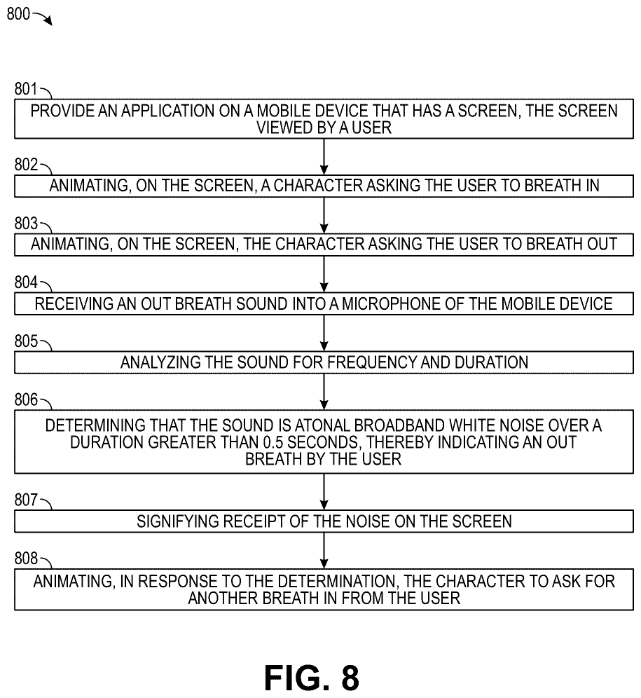

FIG. 8C illustrates a breathing-out part of the breathing exercise on display 602. Character 612 is animated to ask the user to breath out, and he demonstrates a slow, healthy breath out. The sinusoidal diagram on screen 610 shows the preferred timing of the outbreath.

If the user breathes as recommended, smart phone's microphone 630 detects rushing air from the user's breath out. The smart phone analyzes the sound from microphone 630 for frequency and duration and determines that the sound is atonal (i.e., without a tone) broadband white noise over a duration greater than 4, 3, 2, 1.5, 1.25, 1.0, 0.9, 0.8, 0.7, 0.6, 0.5, 0.4, or 0.3 seconds. This indicates a probable out breath by the user.

When a probable out breath is detected, the sinusoidal diagram on screen 610 signified receipt of noise. Further, crystals in the background behind the character glow, encouraging the player to breathe out deeply to help calm down.

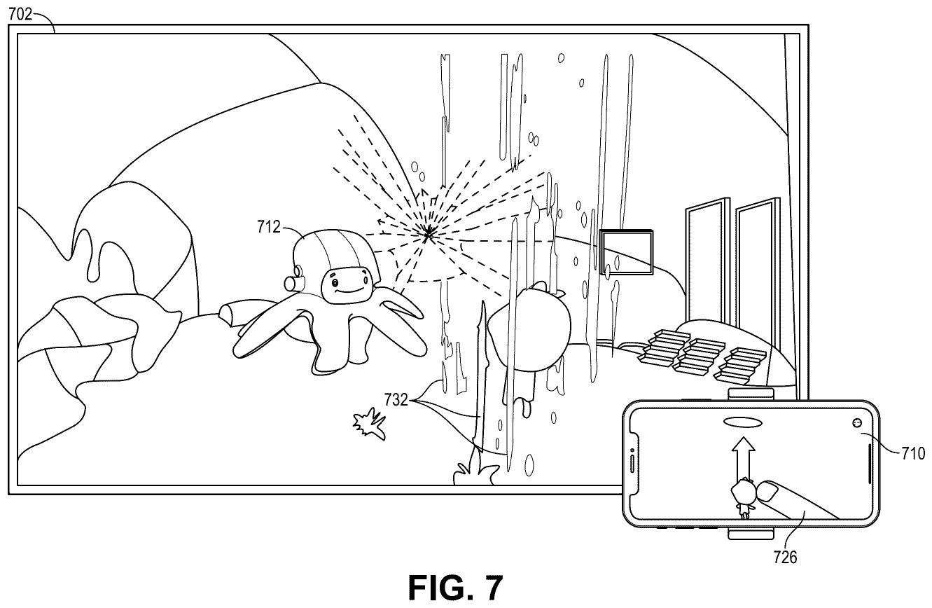

FIG. 7 illustrates character 712 on display 702 thanking the user for helping to calm him down. As a thank you, the character presents an award to the user. The reward is an interactive game effect on the large display using an unconventional control from the mobile device.

User's finger 726 swipes on touch screen 710 of the mobile device to send another character on the TV display out of the picture. In the figure, the user's hand is shown swiping upward on the touch screen of the phone. By doing so, it is indicated that a character gets sent into a portal.

The finger may continue with multiple swipes up on the touch screen. The swipes can produce a light display as shown on the TV display. Alternatively or in addition, snowflakes, leaves, bubbles, glitter, or other flurries of objects that can appear to be streamed onto the primary TV display. The finger may swipe in other directions, such as to the left, right, or bottom, diagonals, polygonal or circular motions. Each of these gestures may indicate a different graphical effect. Further, a player can shake the phone as if sprinkling glitter or candy toppings onto an object on the display.

The graphical effect may be synchronized with the video game elements or unsynchronized. The graphic effect may affect game play, as in a water hose pouring water to put out an on-screen fire, or not affect game play.

Traditional streaming focuses on casting content from a mobile device to a TV without interactive character transitions. Any user interaction with the content is typically limited to basic controls (e.g., play, pause, seek) and does not involve real-time animated characters moving between screens or creating starting graphics effects.

A technical advantage of interaction in embodiments is that a greater variety of video game or other controls may be employed by a user. The content may be more engaging, and younger children may be able to learn hand movements required for touch screen gesturing.

FIG. 8 is a flowchart of process 800 in accordance with an embodiment. In operation 801, an application is provided on a mobile device that has a screen, the screen viewed by a user. In operation 802, a character is animated on the screen asking the user to breath in. In operation 803, the character is animated on the screen asking the user to breath out. In operation 804, an out breath sound is received into a microphone of the mobile device. In operation 805, the sound is analyzed for frequency and duration. In operation 806, the sound is determined to be atonal broadband white noise over a duration greater than 0.5 seconds. This is presumably an out breath by a user. In operation 807, receipt of the noise or sound is signified on the screen. In operation 808, the character is animated, in response to the determination, to ask for another breath in from the user.

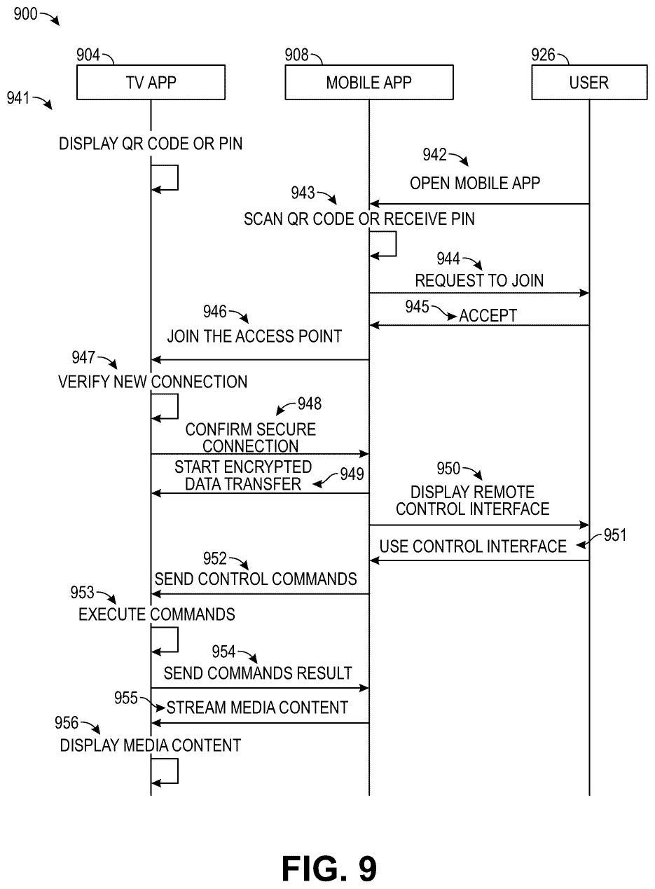

FIG. 9 is a unified modeling language (UML) sequence diagram of communications 900 sent between a smart TV app 904 (which may include an app. on a TV stick), a mobile app. 908 on a smart phone, and user 926.

The exemplary embodiment is a Google Android®-based smart TV system, tailored to deliver an interactive and secure learning experience for children.

A custom Android smart TV system is optimized for primary usage by removing unnecessary applications and streamlining the user experience. It includes a launcher and a secure pairing mechanism with a mobile application. The system uses QR (Quick Response) codes with randomized passwords for secure connection, encrypts data in transit, and offers a gamified user experience for ease of use. This selective hardware configuration ensures relatively optimal data streaming performance.

Mobile applications can be available on both Google Android® and Apple iOS®. Once paired with the smart TV device, the application becomes the secondary display, offering dynamic content and controls to enrich the experience.

In step 941 when the Smart TV is powered on, a QR code or PIN is displayed for pairing. This can include a unique, randomized SSID (service set identifier) and password for the access point. In step 942, the user opens the mobile app. In step 943, the QR code is scanned by the mobile app or a PIN is received. In step 944, the mobile app. requests the user to join, and the user accepts in step 945.

In step 946, the mobile app. joins the access point. This may occur before the start or at other points along the workflow. In step 947, the TV app. verifies the new connection. In step 948, the TV app. confirms a secure connection with the mobile app., and in step 949, the mobile app. starts an encrypted data transfer.

In step 950, the mobile app. displays a remote control interface to the user. In step 951, the user uses the control interface, whose control commands are relayed by the mobile app. to the TV app. in step 952.

In step 953, the TV app. executes the control commands. In step 954, the TV app. sends the commands result to the mobile app. In step 955, the mobile app. streams media content. Step 956 has the TV app. continuing to display media content.

This set of communications enables dual-screen immersive gameplay that enhances interactive entertainment by integrating mobile devices with smart TVs. The system leverages a primary display (e.g., a smart TV) and secondary devices (e.g., smartphones/tablets) to deliver an engaging and interactive gaming experience. Other methods of showing video from a mobile phone on a large display are envisioned.

In some embodiments, a WebRTC (Web Real-Time Communication) module may be used for a streaming and game engine. The mobile device can initialize a game and render both primary and secondary screen content. The WebRTC module establishes a peer-to-peer connection from the mobile device to the smart TV. Gameplay is started when the mobile device sends the primary display content to the smart TV via WebRTC, and the smart TV displays the primary content. A user interacts with the mobile device, triggering game events. The game engine processes inputs and updates both primary and secondary displays. Data transmission occurs when the mobile device streams updates to the smart TV. The smart TV updates the display in real-time based on the streamed data. Synchronized interaction is enabled when the mobile device and smart TV maintain synchronization via continuous WebRTC communication. Both displays reflect real-time game state changes and interactions.

Using a real-time, peer-to-peer communication protocol, such as WebRTC, allows the rendering of both primary and secondary screens on a single mobile device. Current, widely available smart phones have sufficient processing power for high power games. This architecture provides absolute synchronization, because processing is done on one processor or set of closely coupled processors. Rendering both screens on a single device and streaming one to another display is an approach that optimizes performance and user experience. The integration of the WebRTC protocol for real-time peer-to-peer streaming in a dual-screen gaming setup minimizes latency, unlike traditional server-based methods. Also, it offloads processing from central servers.

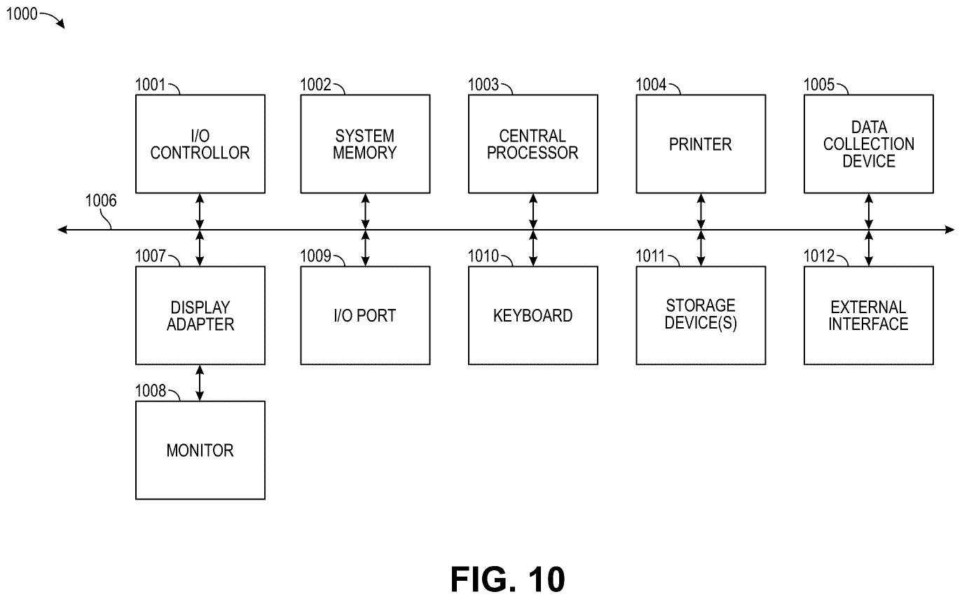

FIG. 10 illustrates an example computer system 1000 for computations. It may utilize any suitable number of subsystems. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other static and mobile devices.

The subsystems shown in the figure are interconnected via a system bus 1006. Additional subsystems such as a printer 1004, keyboard 1010, storage device(s) 1011, monitor 1008 (e.g., a display screen, such as an LED (light emitting diode) screen), which is coupled to display adapter 1007, and others are shown. Peripherals and input/output (I/O) devices, which couple to I/O controller 1001, can be connected to the computer system by any number of means known in the art such as input/output (I/O) port 1009 (e.g., USB, Fire Wire®). For example, I/O port 1009 or external interface 1012 (e.g., Ethernet, Wi-Fi, etc.) can be used to connect computer system 1000 to a wide area network such as the Internet, a mouse input device, or a scanner. The interconnection via system bus 1006 allows the central processor 1003 to communicate with each subsystem and to control the execution of a plurality of instructions from system memory 1002 or the storage device(s) 1011 (e.g., a fixed disk, such as a hard drive, or optical disk), as well as the exchange of information between subsystems. The system memory 1002 and/or the storage device(s) 1011 may embody a computer readable medium. Another subsystem is a data collection device 1005, such as a camera, microphone, accelerometer, and the like. Any of the data mentioned herein can be output from one component to another component and can be output to the user.

A computer system can include a plurality of the same components or subsystems, e.g., connected together by external interface 1012, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” in reference to a temperature or other engineering units includes measurements or settings that are within ±1%, ±2%, ±5%, ±10%, or other tolerances of the specified engineering units as known in the art.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for simultaneous interactive video through multiple electronic devices, the method comprising:
providing an application on a mobile device having a screen;
streaming a video to a large format, fixed display, the video presenting an animated character, the screen and display viewed by a user;
animating the character in the video to depict the character taking steps to initiate communications;
rendering, on the screen of the mobile device, a face-on camera view of the character communicating to the user in a videoconference;
receiving, on the mobile device, a user input; and
rendering, on the screen of the mobile device or on the fixed display, a response to the input.

2. The method of claim 1 further comprising:
depicting, on the screen of the mobile device, a representation of an incoming call on the mobile device.

3. The method of claim 2 further comprising:
detecting an operating system of the mobile device; and
selecting the representation from multiple representations, each representation of the multiple representations associated with a different operating system.

4. The method of claim 2 further comprising:
depicting, on the screen of the mobile device, a representation of an ended call on the mobile device.

5. The method of claim 1 further comprising:
depicting, on the display and simultaneous with the communicating, a second camera view of the character performing the communications, the second view of the character on the display being different from the face-on view of the character.

6. The method of claim 5 wherein the second view of the character is a profile view of the character, a ¾ rear view of the character, or a back view of the character.

7. The method of claim 1 further comprising:
rendering the character to gesticulate non-conventional controls of a video game to be played on the display; and
allowing the user to control the video game using the non-conventional controls.

8. The method of claim 7 wherein the user input includes non-conventional controls selected from the group consisting of touch screen gestures, rotating the mobile device, shaking the mobile device, and speaking or breathing into a microphone of the mobile device.

9. The method of claim 1 further comprising:
detecting a model of the mobile device;
looking up attributes of the mobile device; and
rendering, on the screen of the mobile device, the character pointing off screen to a physical element on the mobile device.

1. A machine-readable tangible medium embodying information indicative of instructions for causing one or more machines to perform operations for simultaneous interactive video through multiple electronic devices, the instructions comprising:
the method of claim 1.

2. A system for simultaneous interactive video through multiple electronic devices, the system comprising:
a memory; and
at least one processor operatively coupled with the memory and executing program code from the memory for:
the method of claim 1.

12. A method for simulating object permanence of animated interactive characters through multiple electronic devices, the method comprising:
providing an application on a mobile device having a screen;
streaming a video to a large format, fixed display, the video presenting an animated character, the screen and display viewed by a user;
depicting the character in the video display preparing to move off of the display;
animating the character moving off of the display;
rendering the character on the screen of the mobile device immediately after the character moving off of the display;
receiving, on the mobile device, a user input to interact with the character on the screen; and
rendering, on the screen of the mobile device, a response of the character to the user input.

13. The method of claim 12 wherein the user input includes touch screen gestures that simulate touching the character.

14. The method of claim 12 wherein the user input includes rotating or shaking the mobile device, the method further comprising:
detecting a rotation or shaking from an accelerometer or gyroscope in the mobile device; and
animating the character in response to the detecting.

15. The method of claim 12 further comprising:
depicting, on the screen of the mobile device, the character preparing to move off of the screen;
animating the character moving off of the screen; and
rendering the character on the video display immediately after the character moving off of the screen.

3. A machine-readable tangible medium embodying information indicative of instructions for causing one or more machines to perform operations for simulating object permanence of animated interactive characters through multiple electronic devices, the instructions comprising:
the method of claim 12.

4. A system for simulating object permanence of animated interactive characters through multiple electronic devices, the system comprising:
a memory; and
at least one processor operatively coupled with the memory and executing program code from the memory for:
the method of claim 12.

18. A method for regulating breathing using a mobile computer device, the method comprising:
providing an application on a mobile device having a screen, the screen viewed by a user;
animating, on the screen, a character asking the user to breath in;
animating, on the screen, the character asking the user to breath out;
receiving an out breath sound into a microphone of the mobile device;
analyzing the sound for frequency and duration;
determining that the sound is atonal broadband white noise over a duration greater than 0.5 seconds, thereby indicating an out breath by the user;
signifying receipt of the noise on the screen; and
animating, in response to the determination, the character to ask for another breath in from the user.

19. The method of claim 18 further comprising:
rendering the character to breathe in and out with the user.

5. A machine-readable tangible medium embodying information indicative of instructions for causing one or more machines to perform operations for regulating breathing using a smart phone, the instructions comprising:
the method of claim 18.

6. A system for regulating breathing using a smart phone, the system comprising:
a memory; and
at least one processor operatively coupled with the memory and executing program code from the memory for:
the method of claim 18.
